(19) United States
(12) Patent Application Publication
(10) Pub. No.: US 2009/0240593 A1
(43) Pub. Date: Sep. 24, 2009

(54) METHOD AND SYSTEM FOR PERMITTING A GIFT EXCHANGE BETWEEN MOBILE STORAGE DEVICES

(75) Inventors: Declan P. Kelly, Shanghai (CN); Jozef P. Van Gassel, Sevenum (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,210

(22) PCT Filed: Dec. 8, 2005
(86) PCT No.: PCT/IB05/54135

§ 371 Date: Jun. 8, 2007

Related U.S. Application Data
(60) Provisional application No. 60/635,236, filed on Dec. 10, 2004.

(51) Int. Cl. G06Q 30/00; G06Q 40/00

(52) U.S. Cl. 705/26; 705/41

(57) ABSTRACT

A method for permitting a gift exchange between mobile storage devices (102) is provided that includes selecting one or more gift contents (204) from a content provider (108). At least a subset of the selected gift contents (204) is purchased from the content provider (108). The selected gift contents (204) are received from the content provider (108). The received gift contents (204) are stored on a donor mobile storage device (102a). At least a subset of the stored gift contents (204) is transferred from the donor mobile storage device (102a) to a receiver mobile storage device (102b). The transferred gift contents (204) correspond to the purchased gift contents (204).

The present invention relates generally to information and commerce distribution and, more particularly, to a method and system for permitting a gift exchange between mobile storage devices.

Many information providers are available on-line for providing downloadable content for purchase by users. These on-line content providers typically require users to access them on-line in order to purchase the content. Thus, if a user wishes to purchase a content as a gift for someone else, conventional systems require the donor to access the content provider on-line along with the receiver in order to provide the payment information and allow the receiver to download the content. Therefore, these systems fail to provide the satisfaction of physically giving a gift to the receiver, such as presenting the receiver with a compact disc or other physical embodiment of the content.

In accordance with the present invention, a method and system for permitting a gift exchange between mobile storage devices are provided that substantially eliminate or reduce disadvantages and problems associated with conventional systems and methods.

According to one embodiment of the present invention, a method for permitting a gift exchange between mobile storage devices is provided. The method includes selecting one or more gift contents from a content provider. At least a subset of the selected gift contents is purchased from the content provider. The selected gift contents are received from the content provider. The received gift contents are stored on a donor mobile storage device. At least a subset of the stored gift contents is transferred from the donor mobile storage device to a receiver mobile storage device. The transferred gift contents correspond to the purchased gift contents.

According to another embodiment of the present invention, a method for permitting a gift exchange between mobile storage devices is provided that includes establishing a network between a donor mobile storage device and a receiver mobile storage device. At least one content is received from the donor mobile storage device on the receiver mobile storage device. The received content is stored as an accessible content on the receiver mobile storage device.

According to yet another embodiment of the present invention, a method for permitting a gift exchange between mobile storage devices is provided that includes receiving a selection of a plurality of gift contents. Payment is received for a subset of the selected gift contents. The selected gift contents are provided to a donor.

According to still another embodiment of the present invention, a mobile storage device is provided that includes a content memory and a content controller. The content memory is operable to store a plurality of accessible contents and a plurality of gift contents. The content controller is operable to convert the gift contents into accessible contents.

Technical advantages of one or more embodiments of the present invention include providing a method for permitting a gift exchange between mobile storage devices. In a particular embodiment, a content provider allows a donor to purchase one or more contents for giving as a gift to a receiver. The purchased gift contents are stored on the donor's mobile storage device. Later, the donor may establish a network between the donor's mobile storage device and the receiver's mobile storage device. At that time, the gift contents are transferred from the donor's mobile storage device to the receiver's mobile storage device and deleted from the donor's mobile storage device. Accordingly, the donor is permitted to purchase the contents and later give the contents as a gift to the receiver. In addition, the physical act of giving a gift is maintained for the donor.

Other technical advantages will be readily apparent to one skilled in the art from the following figures, description, and claims.

Before undertaking the DETAILED DESCRIPTION, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document, those of ordinary skill in the art should understand that in many, if not most instances, such definitions apply to prior, as well as future uses of such defined words and phrases.

For a more complete understanding of the present invention and its advantages, reference is now made to the following description taken in conjunction with the accompanying drawings, wherein like reference numerals represent like parts, in which:

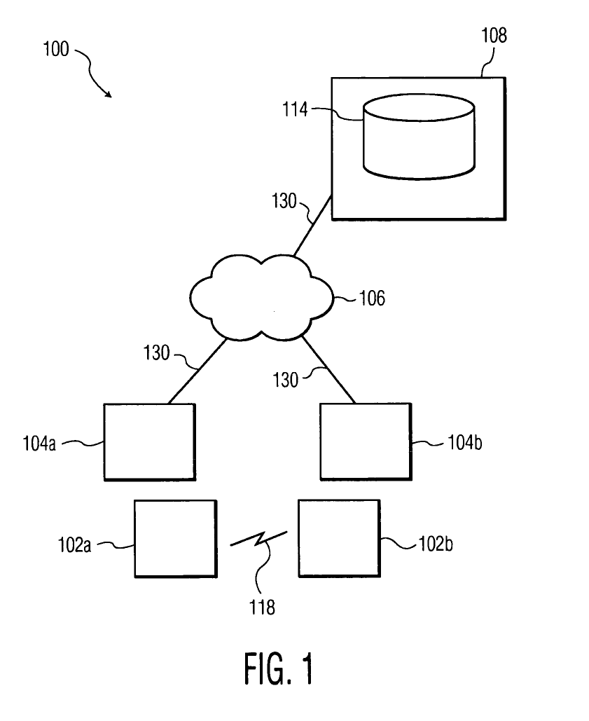

FIG. 1 is a block diagram illustrating a system operable to permit gift exchanges between mobile storage devices in accordance with one embodiment of the present invention;

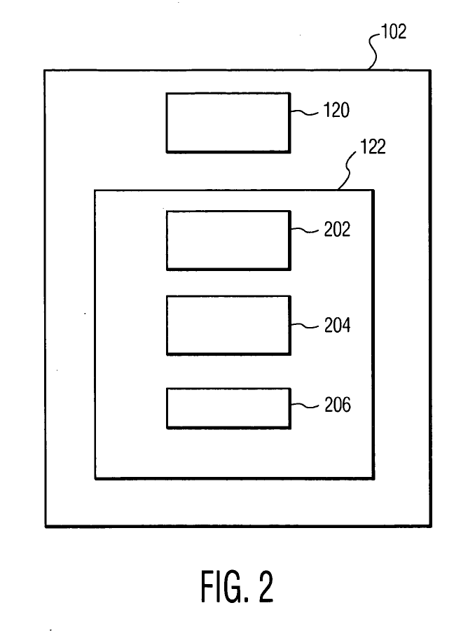

FIG. 2 is a block diagram illustrating one of the mobile storage devices of FIG. 1 in accordance with one embodiment of the present invention;

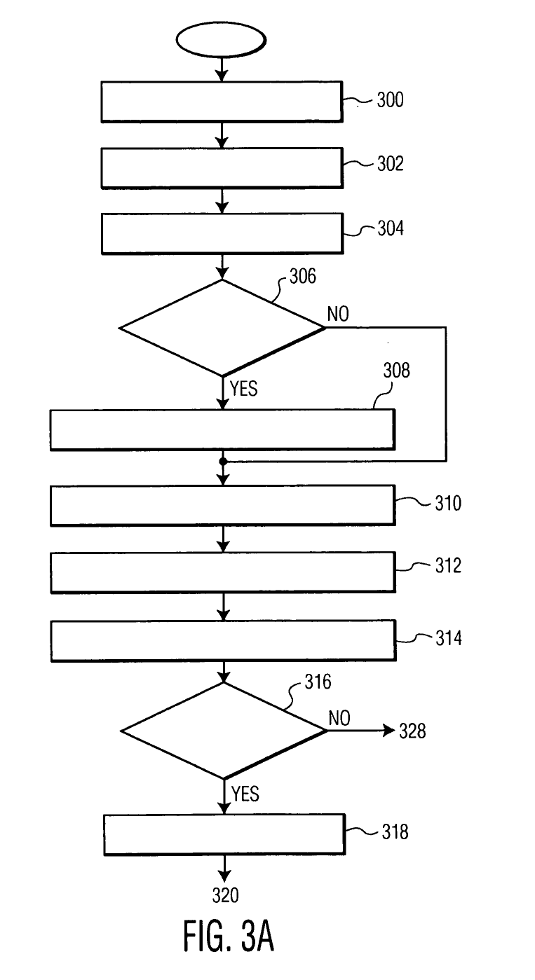

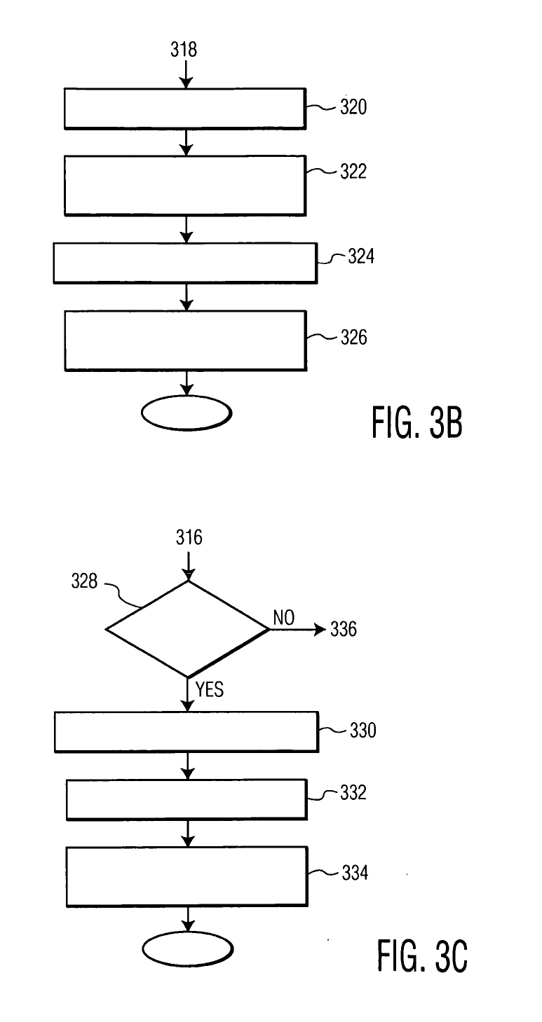

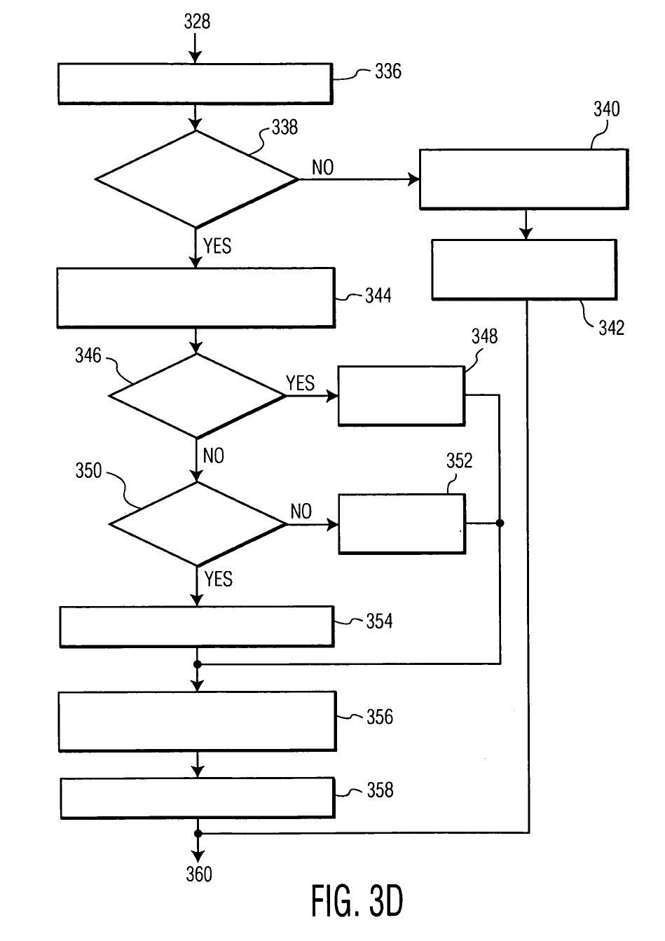

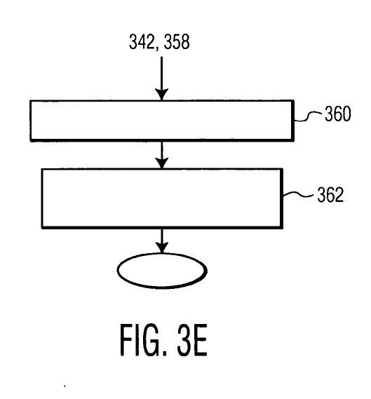

FIG. 3 is a flow diagram illustrating a method for permitting a gift exchange between mobile storage devices from the perspective of the donor in accordance with one embodiment of the present invention;

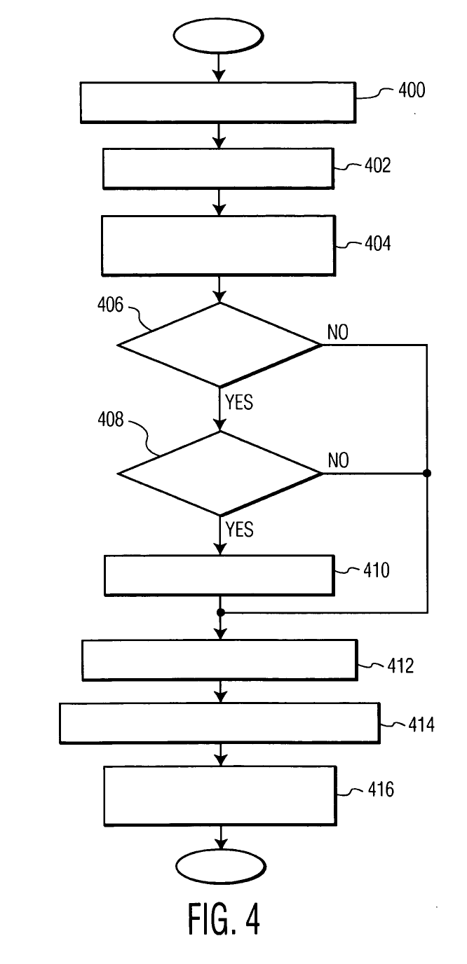

FIG. 4 is a flow diagram illustrating a method for permitting a gift exchange between mobile storage devices from the perspective of the receiver in accordance with one embodiment of the present invention; and

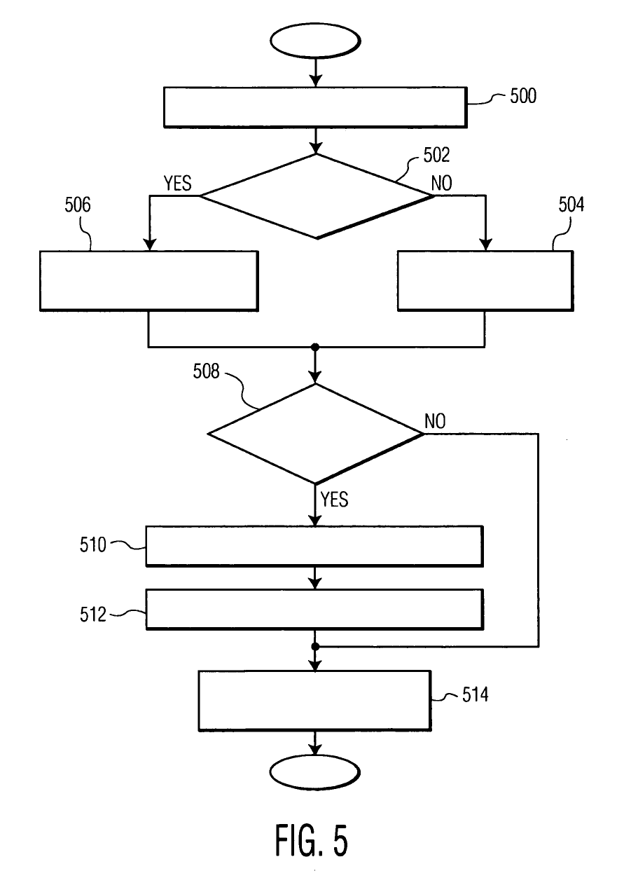

FIG. 5 is a flow diagram illustrating a method for permitting a gift exchange between mobile storage devices from the perspective of the content provider of FIG. 1 in accordance with one embodiment of the present invention.

FIGS. 1 through 5, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged system for providing contents to mobile storage devices.

FIG. 1 is a block diagram illustrating a system 100 operable to permit gift exchanges between mobile storage devices 102 in accordance with one embodiment of the present invention. The system 100 comprises a plurality of mobile storage devices 102, a plurality of network access providers 104 for providing access to a network 106 for the mobile storage devices 102, at least one content provider 108 for providing contents to the mobile storage devices 102, and the network 106, which provides communication between (i) the mobile storage devices 102 and the network access providers 104 and (ii) the content provider 108. It will be understood that the system 100 may comprise any other suitable components, such as servers coupled to the network 106, without departing from the scope of the present invention.

Each mobile storage device 102 may comprise a hard disk-based consumer electronic product, such as an HDD100 or an HDD60 manufactured by Philips or an iPod manufactured by Apple, a laptop computer, or any other suitable device capable of receiving contents from the content provider 108 through the network 106 and a network access provider 104 and storing those contents. As used herein, “each” means every one of at least a subset of the identified items, and “content” means video data, audio data and/or other suitable data that is operable to be executed, displayed, or otherwise operated on a mobile storage device 102. For example, contents may include songs, videos, e-books and the like.

Each mobile storage device 102 may be operable to communicate with other mobile storage devices 102 over a wireless interface 118. In addition, for some embodiments, the mobile storage devices 102 may be operable to communicate with a network access provider 104 and/or the network 106 over the wireless interface 118. The wireless interface 118 may comprise communication channels defined upon radio links, such as an Enhanced Data for GSM (Global System for Mobile communications) Evolution interface, a Wideband Code Division Multiple Access interface, a WiFi interface, an Ultra Wide Band interface, or any other suitable interface.

As described in more detail below in connection with FIG. 2, the mobile storage devices 102 are operable to exchange contents as gifts from one to another. For example, the mobile storage device 102a may act as a donor mobile storage device in order to give one or more contents to the mobile storage device 102b, which represents a receiver mobile storage device. In addition, the mobile storage device 102a may also become a receiver mobile storage device in order to receive one or more contents from the mobile storage device 102b, which would then represent a donor mobile storage device. For simplicity, however, the mobile storage device 102a will be referred to as the donor mobile storage device and the mobile storage device 102b will be referred to as the receiver mobile storage device in the following description.

Each mobile storage device 102 comprises a content controller (not illustrated in FIG. 1) for controlling contents in the device 102 and a content memory (not illustrated in FIG. 1) for storing contents, including gift contents, in the device 102. As described in more detail below in connection with FIG. 2, the content controller is operable to manage the contents stored in the content memory and to synchronize the mobile storage device 102 with a network access provider 104 or any other suitable device.

The network access providers 104 may each comprise a personal computer, an e-hub or any other suitable component that is operable to communicate with a mobile storage device 102 and to provide a physical connection for a mobile storage device 102 to communicate with the network 106. Each of the network access providers 104 may comprise a device to which the mobile storage device 102 may be directly coupled or to which the mobile storage device 102 may be indirectly coupled, such as through a cable or over a wireless interface 118. In addition, each of the network access providers 104 is coupled to the network 106. Thus, the mobile storage devices 102 are operable to communicate with the network 106 through the network access providers 104.

Although the illustrated embodiment comprises two mobile storage devices 102a-b and two corresponding network access providers 104a-b, it will be understood that the system 100 may comprise any suitable number of mobile storage devices 102 and corresponding network access providers 104 without departing from the scope of the present invention.

The content provider 108 is coupled to the network 106 and is operable to provide contents to the mobile storage devices 102. The content provider 108 comprises a content database 114 that is operable to store a plurality of contents that may be purchased by users and downloaded to the mobile storage devices 102. As described in more detail below, the content provider 108 is operable to provide one or more of the contents stored in the content database 114 to the mobile storage devices 102 through the network 106. One or more of these contents may be provided to a donor mobile storage device 102a as gift contents to be given to a receiver mobile storage device 102b. The system 100 may comprise any suitable number of content providers 108, each of which may be operable to provide contents for one or more business entities.

In one embodiment, the network 106 comprises a packet data network, such as the Internet, or other suitable network. However, the network 106 may also comprise any interconnection found on any computer network such as a local area network (LAN), a wide area network (WAN), or any other communications and data exchange systems created by connecting two or more computers.

Each network access provider 104 and the content provider 108 are operable to communicate with the network 106 over communication lines 130, which may be any type of communication link capable of supporting data transfer. In one embodiment, the communication lines 130 may comprise, alone or in combination, Integrated Services Digital Network (ISDN), Asymmetric Digital Subscriber Line (ADSL), T1 or T3 communication lines, hardwire lines, or telephone links. It will be understood that the communication lines 130 may comprise other suitable types of data communication links. The communication lines 130 may also connect to a plurality of intermediate servers between (i) the network 106 and (ii) the network access providers 104 and the content provider 108.

In operation according to one embodiment, a user of a donor mobile storage device 102a accesses the content provider 108 through the network 106. The content provider 108 then presents a plurality of content identifiers, each of which is operable to identify a content stored in the content database 114, for selection by the user. The content provider 108 may also provide any suitable features, such as the ability to search the contents in the content database 114 based on keywords, subject matter and/or any other suitable searching options.

After the user selects one or more contents for purchase as gifts and provides the content provider 108 with payment information, such as credit card or other suitable information, the content provider 108 allows the user to download the purchased gift contents to the network access provider 104a, from which the gift contents may be downloaded onto the donor mobile storage device 102a. As described in more detail below, the user of the donor mobile storage device 102a may be allowed to download more contents than were purchased in order to allow a delayed selection of which contents will be given to the user of the receiver mobile storage device 102b.

The gift contents downloaded into the network access provider 104a and the donor mobile storage device 102a may be inaccessible by the user of the network access provider 104a and the donor mobile storage device 102a. For this embodiment, the gift contents may be encrypted or stored in any other inaccessible manner. Alternatively, the gift contents downloaded into the network access provider 104a and the donor mobile storage device 102a may be accessible to a limited degree. For example, the network access provider 104a and the donor mobile storage device 102a may be able to provide the user with access to a specified portion of each of the gift contents, such as a specified amount of time, a specified amount of text, or any other suitable portion. For this embodiment, the remainder of each of the gift contents may be encrypted or stored in any other inaccessible manner. As yet another alternative, the gift contents may be accessible by the user.

When the user of the donor mobile storage device 102a is ready to give the gift contents to the user of the receiver mobile storage device 102b, the two mobile storage devices 102a and 102b are coupled together by way of an ad hoc wireless peer-to-peer network, through a physical connection such as a cable, or in any other suitable manner. The gift contents are then transferred from the donor mobile storage device 102a to the receiver mobile storage device 102b and deleted from the donor mobile storage device 102a.

When the donor mobile storage device 102a later synchronizes with the network access provider 104a, the gift contents are also deleted from the network access provider 104a. Similarly, when the receiver mobile storage device 102b synchronizes with the network access provider 104b, the gift contents are copied from the receiver mobile storage device 102b to the network access provider 104b.

FIG. 2 is a block diagram illustrating one of the mobile storage devices 102 in accordance with one embodiment of the present invention. The mobile storage device 102 comprises a content controller 120 and a content memory 122. The content memory 122 is operable to store a plurality of accessible contents 202 and a plurality of gift contents 204. The content memory 122 may also be operable to store a wish list 206, in addition to any other suitable data. It will be understood that the mobile storage device 102 may comprise any other suitable components in order to store and provide the contents to the user, such as a speaker, a video screen and/or other suitable components.

The content controller 120 is operable to manage the contents 202 and 204 and the wish list 206 stored in the content memory 122 and to synchronize the mobile storage device 102 with another device, such as a network access device 104 and/or any other suitable device.

The accessible contents 202 comprise contents that have been purchased and are available to the user. For example, for an embodiment in which the mobile storage device 102 comprises an audio jukebox, the accessible contents 202 comprise songs for which the user has paid and, thus, that may be played by the mobile storage device 102 for the user at any time and any number of times.

The gift contents 204 comprise contents that have been selected by the user, as a donor, to be given to another user, as a receiver. After a gift content 204 is transferred from the donor mobile storage device 102a to the receiver mobile storage device 102b, the gift content 204 is stored as an accessible content 202 on the receiver mobile storage device 102b and is deleted from the gift contents 204 of the donor mobile storage device 102a.

According to one embodiment, the gift contents 204 have been purchased by the donor. However, according to another embodiment described in more detail below, the donor may have the option of storing several contents and/or sets of contents as gift contents 204 when only a subset of those gift contents 204 have been purchased. For example, for this embodiment, the donor may select three contents as possible gifts for the receiver, while purchasing only one content. All three of the selected contents are stored as gift contents 204 in the donor mobile storage device 102a. The donor may then decide later which of the three contents to give as a gift. Once the content is transferred to the receiver mobile storage device 102b, all three of the selected contents are deleted from the content memory 122 of the donor mobile storage device 102a.

For one embodiment, the gift contents 204 are inaccessible by the user of the donor mobile storage device 102a or accessible to a limited degree. For this embodiment, the gift contents 204 are made available to the user of the donor mobile storage device 102a with additional restrictions as compared to accessible contents 202. For example, contents stored as accessible contents 202 may have some restrictions with regard to copying or other suitable restrictions. However, gift contents 204 may be subject to additional restrictions.

Thus, for the embodiment in which the mobile storage device 102 comprises an audio jukebox, the donor mobile storage device 102a may not play the gift contents 204, may play the gift contents 204 only a specified number of times, may play only a specified portion of the gift contents 204 and/or may restrict the accessibility of the gift contents 204 in any other suitable manner. For example, for one embodiment, the gift contents 204 or a portion of each of the gift contents 204 may be encrypted until they are transferred to a receiver mobile storage device 102b, at which time the content controller 120 of either the donor or the receiver mobile storage device 102 is operable to decrypt the contents for storage as accessible contents 202 on the receiver mobile storage device 102b.

Though shown separately, the contents 202 and 204 may be implemented together in the content memory 122. For one embodiment, the address of the content may simply be identified as belonging to an accessible or a gift content 202, 204. Alternatively, a Digital Rights Management (DRM) system can be used to indicate the rights the user has to the content, in particular whether the content is directly accessible or in the case of a gift, for example, access to the content is restricted. Furthermore, the DRM system can specify exactly what the restricted access rights to the gift content are for the donor user. It will be understood that the contents 202 and 204 may be otherwise suitably identified as accessible or gift contents 202, 204 without departing from the scope of the present invention.

The optional wish list 206 comprises a list of contents that have been identified by the user as contents that he or she may want to purchase at a later time or may want to be given as a gift. It will be understood that the wish list 206 may also be stored in the content provider 108 in addition to or instead of the mobile storage device 102. The wish list 206 may also comprise a priority for types of contents that the user desires in addition to or instead of a list of specific contents. For example, for the embodiment in which the mobile storage device 102 comprises an audio jukebox, the wish list 206 may comprise a priority in the form of a list of song genres in the order in which the user prefers those types of genres, such as rock, classical and jazz.

As described in more detail below, when the user is being given a gift content 204 that may be selected from multiple gift contents 204, the wish list 206 may be used by the content controller 120 in selecting which of the gift contents 204 to be transferred from the donor mobile storage device 102a to the user's receiver mobile storage device 102b. FIG. 3 is a flow diagram illustrating a method for permitting a gift exchange between mobile storage devices 102 from the perspective of the donor in accordance with one embodiment of the present invention. The method begins at step 300 where the donor accesses the content provider 108 through the network access provider 104a.

At step 302, the donor selects at least one gift content from the content database 114. Although the following description refers to a single gift content, it will be understood that the donor may select any combination of gift contents and/or sets of gift contents for giving to the receiver (or to more than one receiver) without departing from the scope of the present invention. Furthermore, as described in more detail below, the donor may select more than one option for giving to the receiver and then give only a subset of the options to the receiver. For example, for the embodiment in which the mobile storage devices 102 comprise audio jukeboxes, the donor may select five songs as options, while planning to give only two of the songs to the receiver.

At step 304, the donor purchases the selected gift content. For example, the donor may provide payment information, such as credit card or other suitable information, to the content provider 108. If the donor has selected more options than will be given to the receiver, the donor only purchases the number of gift contents that will actually be given to the receiver.

At decisional step 306, the donor may be provided with the option of personalizing the gift content. If the donor decides to personalize the gift content, the method follows the Yes branch from decisional step 306 to step 308. At step 308, the donor provides the personalization information to the content provider 108. For example, the donor may provide a text, audio and/or video message, a photograph, clip art and/or any other suitable information that may be used to personalize the gift content. It will be understood that, instead of or in addition to being provided by the donor, the personalization information may also be selected from choices provided by the content provider 108.

Returning to decisional step 306, if the donor decides not to personalize the gift content or if the personalization option is not provided for the donor, the method follows the No branch from decisional step 306 to step 310. In addition, from step 308, the method continues to step 310.

At step 310, the donor receives the selected gift content on the donor's network access provider (NAP) 104a. At step 312, the donor synchronizes the donor mobile storage device (DMSD) 102a with the donor's network access provider 104a. At step 314, the donor receives the gift content 204 on the donor mobile storage device 102a.

At decisional step 316, the donor may decide to return the gift content 204 instead of giving the gift content 204 to the receiver. If the donor does decide to return the gift content 204, the method follows the Yes branch from decisional step 316 to step 318.

At step 318, the donor accesses the content provider 108 through the network access provider 104a. At step 320, the donor selects a “gift return” option and the donor receives a refund or credit from the content provider 108. At step 322, the gift content is deleted from the library in the donor's network access provider 104a. At step 324, the donor synchronizes the donor mobile storage device 102a with the donor's network access provider 104a. At step 326, the gift content 204 is deleted from the donor mobile storage device 102a, at which point the method comes to an end.

Returning to decisional step 316, if the donor decides not to return the gift content 204, the method follows the No branch from decisional step 316 to decisional step 328. At decisional step 328, the donor may decide to keep the gift content 204 instead of giving the gift content 204 to the receiver. If the donor does decide to keep the gift content 204, the method follows the Yes branch from decisional step 328 to optional step 330.

At optional step 330, the donor synchronizes the donor mobile storage device 102a with the donor's network access provider 104a. At step 332, the donor selects a “keep gift” option. It will be understood that if the content controller 120 is operable to provide the donor with the “keep gift” option, the donor mobile storage device 102a does not need to be synchronized with the donor's network access provider 104a before the donor selects the “keep gift” option. In addition, as another alternative, the content provider 108 may provide the “keep gift” option, in which case the donor accesses the content provider 108 before selecting the “keep gift” option. At step 334, the content controller 120 converts the gift content 204 into an accessible content 202, at which point the method comes to an end.

Returning to decisional step 328, if the donor does not decide to keep the gift content 204, the method follows the No branch from decisional step 328 to step 336. At step 336, the donor mobile storage device 102a and the receiver mobile storage device (RMSD) 102b establish a network with each other. The network may comprise an ad hoc wireless peer-to-peer network. However, it will be understood that a network may be established through a physical connection, such as a cable, or in any other suitable manner.

At decisional step 338, a determination is made regarding whether or not there are multiple options for the gift content 204 that is to be provided to the receiver. If there are not multiple options from which to choose the gift content 204, the method follows the No branch from decisional step 338 to step 340.

At step 340, the gift content 204 is transferred from the donor mobile storage device 102a to the receiver mobile storage device 102b. As used herein, “transferred” means that the gift content 204 is copied from the content memory 122 of the donor mobile storage device 102a and stored in the content memory 122 of the receiver mobile storage device 102b as an accessible content 202. For one embodiment, the content controller 120 of the donor mobile storage device 102a converts the gift content 204 into an accessible content 202 before copying the content to the receiver mobile storage device 102b. For another embodiment, the content controller 120 of the receiver mobile storage device 102b converts the gift content 204 received from the donor mobile storage device 102a into an accessible content 202. At step 342, the transferred gift content 204 is deleted from the content memory 122 of the donor mobile storage device 102a.

Returning to decisional step 338, if there are multiple options from which to choose the gift content 204, the method follows the Yes branch from decisional step 338 to step 344. At step 344, any options that are already stored as accessible contents 202 in the content memory 122 of the receiver mobile storage device 102b may be removed as possible options for the gift.

At decisional step 346, a determination is made regarding whether or not a user is to make the selection as to which option will be given as a gift. If a user is to make the selection, the method follows the Yes branch from decisional step 346 to step 348. At step 348, the donor mobile storage device 102a receives the user selection from either the donor or the receiver.

Returning to decisional step 346, if the selection is not to be made by a user, the method follows the No branch from decisional step 346 to decisional step 350. At decisional step 350, a determination is made regarding whether or not the donor mobile storage device 102a is to make the selection as to which option will be given as a gift. If the donor mobile storage device 102a is not to make the selection, the method follows the No branch from decisional step 350 to step 352. At step 352, the content controller 120 for the receiver mobile storage device 102b selects the gift content 204 to be received based on the wish list 206 for the receiver.

Returning to decisional step 350, if the donor mobile storage device 102a is to make the selection, the method follows the Yes branch from decisional step 350 to step 354. At step 354, the content controller 120 for the donor mobile storage device 102a selects the gift content 204 to be received based on a priority selected by the donor. The priority selected by the donor may comprise a list of the gift contents 204 in a particular order, a list of types of gift contents 204 in a particular order and/or any other suitable priority defined by the donor.

From steps 348, 352 and 354, the method continues to step 356. It will be understood that if no match is found on a wish list 206 in step 352 or based on a priority defined by the donor in step 354, the content controller 120 of the donor mobile storage device 102a may prompt the donor or the receiver to provide a selection before the method continues to step 356.

At step 356, the selected gift content 204 is transferred from the donor mobile storage device 102a to the receiver mobile storage device 102b. At step 358, the transferred gift content 204 and the remaining options that were not selected to be given to the receiver are deleted from the content memory 122 of the donor mobile storage device 102a.

From steps 342 and 358, the method continues to step 360. At step 360, the donor synchronizes the donor mobile storage device 102a with the donor's network access provider 104a. At step 362, the donor's network access provider 104a determines that the gift content 204 has been transferred to the receiver mobile storage device 102b and deletes the gift content from the library in the donor's network access provider 104a, at which point the method comes to an end.

FIG. 4 is a flow diagram illustrating a method for permitting a gift exchange between mobile storage devices 102 from the perspective of the receiver in accordance with one embodiment of the present invention. The method begins at step 400 where the receiver mobile storage device 102b and the donor mobile storage device 102a establish a network with each other. The network may comprise an ad hoc wireless peer-to-peer network. However, it will be understood that a network may be established through a physical connection, such as a cable, or in any other suitable manner.

At step 402, the receiver mobile storage device 102b receives a gift content 204 from the donor mobile storage device 102a. Although the following description refers to a single gift content 204, it will be understood that the receiver may receive any combination of gift contents and/or sets of gift contents from the donor without departing from the scope of the present invention.

At step 404, the receiver mobile storage device 102b stores the gift content 204 as an accessible content 202 in the content memory 122 of the receiver mobile storage device 102b. For one embodiment, the content controller 120 of the receiver mobile storage device 102b converts the gift content 204 received from the donor mobile storage device 102a into an accessible content 202. For another embodiment, the content controller 120 of the donor mobile storage device 102a converts the gift content 204 into an accessible content 202 before copying the content to the receiver mobile storage device 102b.

At decisional step 406, a determination is made regarding whether or not the accessible content 202 received as a gift has been personalized. If the content is personalized, the method follows the Yes branch from decisional step 406 to decisional step 408.

At decisional step 408, a determination is made regarding whether or not the receiver is able to and wants to delete the personalization of the content. For example, according to one embodiment, the receiver may be unable to delete the personalization. For other embodiments, the receiver may be able to delete the personalization at any time or may be able to delete the personalization only after a specified period of time has passed and/or the content has been accessed a specified number of times. If the receiver is able to and wants to delete the personalization, the method follows the Yes branch from decisional step 408 to step 410. At step 410, the personalization of the content is deleted and the method continues to step 412.

Returning to decisional step 408, if the receiver is unable to or does not want to delete the personalization, the method follows the No branch from decisional step 408 to step 412. Also, returning to decisional step 406, if the content is not personalized, the method follows the No branch from decisional step 406 to step 412.

At step 412, the receiver synchronizes the receiver mobile storage device 102b with the receiver's network access provider 104b. At step 414, the receiver's network access provider 104b determines that the content memory 122 of the receiver mobile storage device 102b has a new accessible content 202 and stores that content in the library in the receiver's network access provider 104b. At optional step 416, the receiver's network access provider 104b may notify the content provider 108 that the receiver has received the content, at which point the method comes to an end.

FIG. 5 is a flow diagram illustrating a method for permitting a gift exchange between mobile storage devices 102 from the perspective of the content provider 108 in accordance with one embodiment of the present invention. The method begins at step 500 where the content provider 108 receives a selection of a gift content from a donor.

At decisional step 502, the content provider 108 determines whether or not the donor has selected multiple options for the gift content. If the donor has not selected multiple options for the gift content, the method follows the No branch from decisional step 502 to step 504. At step 504, the content provider 108 receives payment information from the donor for the gift content.

Returning to decisional step 502, if the donor has selected multiple options for the gift content, the method follows the Yes branch from decisional step 502 to step 506. At step 506, the content provider 108 receives payment information from the donor for a subset of the selected gift contents.

From steps 504 and 506, the method continues to decisional step 508. At decisional step 508, the content provider 108 makes a determination regarding whether or not the gift content is to be personalized. If the gift content is to be personalized, the method follows the Yes branch from decisional step 508 to step 510.

At step 510, the content provider 108 receives the personalization information from the donor. For example, the content provider 108 may receive from the donor a text, audio and/or video message, a photograph, clip art and/or any other suitable information that may be used to personalize the gift content. It will be understood that, instead of or in addition to being received from the donor, the personalization information may also be provided by the content provider 108 as choices for the donor to select. At step 512, the content provider 108 adds the personalization information to the gift content and the method continues to step 514. It will be understood that the personalization may be done independently of the content provider 108. For example, a CD cover may be replaced with a card including a handwritten element, a handwritten comment may be placed on top of a CD cover, or other suitable personalization may be done in any other suitable manner.

Returning to decisional step 508, if the donor does not wish to personalize the gift content or if the donor does not have the option of personalizing the gift content, the method follows the No branch from decisional step 508 to step 514.

At step 514, the content provider 108 copies the gift content to the donor's network access provider 104a, at which point the method comes to an end.

It will be understood that, although the methods described above are one example of a particular embodiment, other embodiments may be implemented. For one other embodiment, for example, the donor may give to a receiver one or more of his or her accessible contents 202 that were not purchased as a gift in addition to or instead of being able to purchase contents originally intended as gifts. For this embodiment, the donor may be restricted to giving accessible contents 202 that were purchased from the content provider 108 in order to ensure that the contents 202 have suitable copy protection.

Although the present invention has been described with several embodiments, various changes and modifications may be suggested to one skilled in the art. It is intended that the present invention encompass such changes and modifications as fall within the scope of the appended claims.

1. A method for permitting a gift exchange between mobile storage devices (102), comprising:
selecting one or more gift contents (204) from a content provider (108);
purchasing at least a subset of the selected gift contents (204) from the content provider (108);
receiving the selected gift contents (204) from the content provider;
storing the received gift contents (204) on a donor mobile storage device (102a); and
transferring at least a subset of the stored gift contents (204) from the donor mobile storage device (102a) to a receiver mobile storage device (102b), the transferred gift contents (204) corresponding to the purchased gift contents (204).

2. The method of claim 1, further comprising deleting the stored gift contents (204) from the donor mobile storage device (102a).

3. The method of claim 2, receiving the selected gift contents (204) from the content provider (108) comprising receiving the selected gift contents (204) on a network access provider (104a), storing the selected gift contents (204) on the network access provider (104a), synchronizing the donor mobile storage device (102a) with the network access provider (104a), and receiving the selected gift contents (204) on the donor mobile storage device (102a).

4. The method of claim 3, further comprising:
synchronizing the donor mobile storage device (102a) with the network access provider (104a) subsequent to deleting the stored gift contents (204) from the donor mobile storage device (102a); and
deleting the stored gift contents (204) from the network access provider (104a).

5. The method of claim 1, further comprising establishing a network between the donor mobile storage device (102a) and the receiver mobile storage device (102b).

6. The method of claim 5, the network comprising an ad hoc peer-to-peer wireless network.

7. The method of claim 1, the stored gift contents (204) comprising a plurality of options for gifts, the method further comprising removing as options for gifts the stored gift contents (204) previously stored on the receiver mobile storage device (102b).

8. The method of claim 1, the purchased gift contents (204) comprising less than all the selected gift contents (204), transferring at least a subset of the stored gift contents (204) from the donor mobile storage device (102a) to the receiver mobile storage device (102b) comprising transferring a subset of the stored gift contents (204) based on a user selection.

9. The method of claim 1, the purchased gift contents (204) comprising less than all the selected gift contents (204), transferring at least a subset of the stored gift contents (204) from the donor mobile storage device (102a) to the receiver mobile storage device (102b) comprising transferring a subset of the stored gift contents (204) based on a wish list (206) stored on the receiver mobile storage device (102b).

10. The method of claim 1, the purchased gift contents (204) comprising less than all the selected gift contents (204), transferring at least a subset of the stored gift contents (204) from the donor mobile storage device (102a) to the receiver mobile storage device (102b) comprising transferring a subset of the stored gift contents (204) based on a priority.

11. The method of claim 1, further comprising converting the at least a subset of the stored gift contents (204) to be transferred into accessible contents (202).

12. The method of claim 1, further comprising providing personalization information to the content provider (108) to personalize the selected gift contents (204).

13. A method for permitting a gift exchange between mobile storage devices (102), comprising:
establishing a network between a donor mobile storage device (102a) and a receiver mobile storage device (102b);
receiving at least one content from the donor mobile storage device (102a) on the receiver mobile storage device (102b); and
storing the received content as an accessible content (202) on the receiver mobile storage device (102b).

14. The method of claim 13, the received content comprising a gift content (204), the method further comprising converting the gift content (204) into an accessible content (202).

15. The method of claim 13, the received content comprising an accessible content (202).

16. The method of claim 13, further comprising deleting any personalization of the accessible content (202).

17. The method of claim 13, further comprising:
synchronizing the receiver mobile storage device (102b) with a network access provider (104b); and
storing the accessible content (202) on the network access provider (104b).

18. The method of claim 17, further comprising notifying a content provider (108) of receipt of the accessible content (202).

19. A method for permitting a gift exchange between mobile storage devices (102), comprising:
receiving a selection of a plurality of gift contents (204);
receiving payment for a subset of the selected gift contents (204); and
providing the selected gift contents (204) to a donor.

20. The method of claim 19, providing the selected gift contents (204) to a donor comprising copying the selected gift contents (204) to a network access provider (104a) for the donor.

21. The method of claim 19, further comprising:
receiving personalization information from the donor; and
adding the personalization information to the selected gift contents (204).

22. A mobile storage device (102), comprising:
a content memory (122) operable to store a plurality of accessible contents (202) and a plurality of gift contents (204); and
a content controller (120) operable to convert the gift contents (204) into accessible contents (202).

23. The mobile storage device (102) of claim 22, the content controller (120) further operable to transfer one or more of the stored gift contents (204) to a receiver mobile storage device (102b).

24. The mobile storage device (102) of claim 23, the content controller (120) further operable to delete the transferred gift contents (204) from the content memory (122).

25. The mobile storage device (102) of claim 23, the gift contents (204) comprising a plurality of options for gifts, the content controller (120) further operable to remove as options for gifts the gift contents (204) previously stored on the receiver mobile storage device (102b) as accessible contents (202).

26. The mobile storage device (102) of claim 23, the content controller (120) operable to transfer one or more of the stored gift contents (204) to the receiver mobile storage device (102b) based on a user selection.

27. The mobile storage device (102) of claim 23, the content controller (120) operable to transfer one or more of the stored gift contents (204) to the receiver mobile storage device (102b) based on a wish list (206) stored on the receiver mobile storage device (102b).

28. The mobile storage device (102) of claim 23, the content controller (120) operable to transfer one or more of the stored gift contents (204) to the receiver mobile storage device (102b) based on a priority.

29. The mobile storage device (102) of claim 22, the content controller (120) further operable to synchronize the mobile storage device (102) with a network access provider (104).

30. The mobile storage device (102) of claim 22, the content controller (120) further operable to establish a network between the mobile storage device (102) and a receiver mobile storage device (102b).

31. The mobile storage device (102) of claim 22, the network comprising an ad hoc peer-to-peer wireless network.

32. The mobile storage device (102) of claim 22, the content controller (120) further operable to receive at least one content from a donor mobile storage device (102a) and to store the received content as an accessible content (202).
